(19) United States
(12) Patent Application Publication
(10) Pub. No.: US 2014/0030379 A1
(43) Pub. Date: Jan. 30, 2014

(54) MODIFIED DISODIUM PYROPHOSPHATE

(71) Applicant: Wolfgang Bouchain, Wiesbaden (DE)

(72) Inventor: Wolfgang Bouchain, Wiesbaden (DE)

(73) Assignee: CHEMISCHE FABRIK BUDENHEIM KG, Budenheim (DE)

(21) Appl. No.: 13/984,086

(22) PCT Filed: Feb. 7, 2012
(86) PCT No.: PCT/EP2012/052034

§ 371 Date: Oct. 17, 2013

(30) Foreign Application Priority Data
Feb. 8, 2011 (DE) 10 2011 003 816.7

(51) Int. Cl. A21D 8/04; C01B 25/30

(52) U.S. Cl. CPC A21D 8/045; C01B 25/305
USPC 426/18; 423/309

(57) ABSTRACT

Delayed reaction modified disodium dihydrogen diphosphate (SAPP), the preparation thereof and the use thereof as a leavening acid for the production of baked goods. The process for the preparation of the modified disodium dihydrogen diphosphate (SAPP), includes adding an aqueous solution containing at least one of sodium hydroxide and sodium carbonate to an aqueous phosphoric acid solution containing at least one compound of magnesium, calcium, potassium, aluminium the total amount of magnesium plus calcium plus potassium plus aluminium being at least 300 ppm, to obtain an aqueous solution product and dewatering the aqueous solution product at a temperature in the range of from 190 to 250° C. to obtain a modified disodium dihydrogen diphosphate product having an orthophosphate content, measured as P₂O₅, of <5.0 wt. %.

### CROSS REFERENCE TO RELATED APPLICATIONS

This application is a nationalization of International Application PCT/EP2012/052034 filed Feb. 7, 2012 and claims priority from German Application DE 102011003816.7 filed Feb. 8, 2011 both of which are incorporated by reference.

### BACKGROUND OF THE INVENTION

The invention relates to delayed-reaction modified disodium dihydrogen diphosphate (SAPP), the preparation thereof and the use thereof as a leavening acid for the production of baked goods.

In the production of baked goods, leavening agents which release gas, as a rule carbon dioxide, during the production are added to the mixtures or doughs. This carbon dioxide loosens the baked goods.

Yeasts evolve carbon dioxide during fermentation and are therefore employed as leavening agents for loosening doughs. Two-component leavening agents were developed at the start of the 19th century as a substitute for yeast. Soda (sodium bicarbonate, sodium hydrogen carbonate) was first added to the dough and the carbon dioxide bonded therein was released by hydrochloric acid added later. Since hydrochloric acid was not easy to handle, tartar (potassium hydrogen tartrate) was later added as the acid carrier instead of hydrochloric acid. Baking powders of soda, tartar and starch as a release agent were already obtainable in the mid-19th century. On this basis, Dr. August Oetker brought his baking powder “Backin”, produced industrially for the first time, on to the market in about 1900.

A baking powder which comprised monocalcium phosphate (Ca(H₂PO₄)₂ H₂O) instead of tartar and was called “powdered phosphoric acid” was likewise developed in the mid-19th century. Monocalcium phosphate in anhydrous form was later employed.

In order to achieve a delayed evolution of carbon dioxide in the dough or in the mixture, the powder particles of the reaction partners were coated with sparingly water-soluble layers, e.g. soda with a wax-like fat or the acid phosphate with sparingly soluble calcium phosphate. The introduction of sodium acid pyrophosphate (disodium dihydrogen diphosphate, SAPP, Na₂H₂P₂O₇) into the production of baking powder in 1901 was a breakthrough. This phosphate serves as an acid carrier and leads to release of the majority of the carbon dioxide from the carbon dioxide carrier first in the baking oven, that is to say when the dough or mixture is heated (“after-leavening”). There was therefore the possibility of baking dough and mixtures after intermediate storage (expediently refrigerated or frozen). In addition to these baking powders, the action of which is based on the reaction of acid carriers with carbon dioxide carriers, there were the one-component baking powders of hartshorn salt and potash.

Depending on the point in time of release of the gas before baking during preparation of the dough or mixture or first during heating in the baking oven, one speaks of pre-leavening or after-leavening (oven leavening). Using the ratio between pre- and after-leavening of a leavening agent, it is possible to influence the development in volume and pore structure of the baked products for the individual baked goods.

Currently almost exclusively soda (sodium hydrogen carbonate, sodium bicarbonate, NaHCO₃) is used as a carbon dioxide carrier. It is also possible to employ potassium hydrogen carbonate, sodium carbonate, potash (potassium carbonate) and amorphous calcium carbonate.

If soda is coated e.g. with hard fats in order to avoid a fast reaction, fine grain sizes (≦15 μm) must be employed, and it must be ensured that no agglomerates form. Coarse coated grains and agglomerates do not dissolve completely in the mixture and due to locally demarcated increases in pH lead to undesirable punctiform discolorations in the crumb.

There is a large number of substances here. Depending on the desired ratio between pre-leavening (during preparation of the dough or mixture) and after-leavening (in the baking oven), they are employed individually for “simple” baking powders or in combinations with different ratios of amounts for “double” baking powders. Examples of acid carriers which are used are anhydrous citric acid, tartaric acid, tartar, sodium acid pyrophosphate (SAPP), monocalcium phosphate monohydrate, anhydrous monocalcium phosphate, sodium aluminium phosphate, glucono-delta-lactone etc.

Sodium hydrogen carbonate also releases carbon dioxide during baking without addition of acid; although to a lesser extent than in combination with an acid carrier. These baked products moreover have a slightly soapy flavour note.

In simplified form, the formation of gaseous carbon dioxide from a two-component baking powder with an acid carrier and sodium hydrogen carbonate proceeds according to the equation

NaHCO₃+acid→CO₂+Na salt of the acid+H₂O.

Only in practically anhydrous baked goods are the reaction products present as a salt, in others this largely dissociates into sodium cations and acid anions. Depending on the given pH, the anions of the polybasic acids carry one or more negative charges. The osmotic circumstances and the nature and amount of enzymes present likewise influence the nature of the products formed. Diphosphate ions can be cleaved (e.g. under the influence of phosphatase) into two monophosphate ions; monophosphates can undergo condensation to oligophosphates. Even if a refined analysis is used, in the case of phosphates it is not possible to clarify what compounds are actually present in the baked goods because of the inescapable formation of artefacts.

The dough rate of reaction (ROR) of the acid carrier—standard test. The dough rate of reaction, also called ROR, indicates the extent to which the acid carrier already effects an evolution of gas in the mixture, that is to say a “pre-leavening”. The ROR is determined in a standard dough. For this, wheat flour (type 550; 171 g), vegetable fat (partly hardened; 18 g) and sodium chloride (3 g) are mixed in a temperature-controlled laboratory kneader until a temperature of 27° C. is reached. Thereafter, sodium hydrogen carbonate (2.265 g) and the acid carrier are added and the dough is kneaded again for 3 min. In the case of sodium acid pyrophosphate (SAPP), 3.171 g of this acid carrier are employed. After it has been ensured that the apparatus is closed gas-tight, distilled water (120 g) preheated to 27° C. and a 1% strength calcium chloride solution (3.5 ml) are introduced into the reservoir vessel and allowed to run into the premix in the kneader. The tap of the reservoir vessel is closed immediately, the kneader is switched on and recording of the time is started. The kneading time is again 3 min. With the kneader switched off, the evolution of gas is observed for a further 5 min. The carbon dioxide evolved is collected in a gas burette, and after 8 minutes the volume is measured. The percentage (out of 100% total carbon dioxide in the sodium hydrogen carbonate) of carbon dioxide released under these conditions is the ROR of the acid carrier. The standard test described here is also the basis for the determination of the dough rate of reaction (ROR) according to the present invention.

The ROR of fast-reacting organic acids, such as citric acid, tartaric acid and also tartar, is 60 to 70. Various types of sodium acid pyrophosphate (SAPP) and e.g. also sodium aluminium phosphate, on the other hand, have ROR values of from less than 20 to 40. GDL (glucono-delta-lactone) occupies an intermediate position. The evolution of gas starts after somewhat of a delay, and after 8 minutes about 30% of the carbon dioxide present is released (ROR=30). While with other acid carriers the evolution of gas in the unbaked mixture or in the unbaked dough comes to a certain stop, the evolution of gas here progresses continuously, as in the case of yeast fermentation. The kinetics of lactone cleavage, which forms gluconic acid from the non-acid reacting lactone, are the reason for this.

Sodium acid pyrophosphate (SAPP) is obtained by reaction of an aqueous solution of sodium hydroxide or sodium carbonate with phosphoric acid to give a monosodium phosphate solution and subsequent dewatering. Pure SAPP has a dough rate of reaction (ROR) in accordance with the abovementioned standardized measurement method of the order of about 40. An SAPP having a lower ROR is also called a delayed-action SAPP or delayed SAPP. Depending on the ROR achieved, the SAPP variants are called, for example, SAPP 40, SAPP 36, SAPP 28, SAPP 20, SAPP 15 and SAPP 10.

To reduce the ROR, i.e. to reduce the pre-leavening in favour of a higher after-leavening, it is known to modify SAPP by the addition of metal ions, in particular by the addition of a relatively large amount of aluminium ions. Because of concerns about the effects of aluminium on health and the resulting legal limit values for uptake of aluminium through food, however, there are efforts generally to considerably reduce the aluminium content in foodstuffs.

For the preparation of an SAPP having a delayed dough rate of reaction, U.S. Pat. No. 2,844,437 proposes adding amounts, based on the end product, of from 0.05 to 0.30 wt. % of calcium oxide (CaO) and 0.05 to 0.30 wt. % of aluminium oxide (Al₂O₃) to the phosphoric acid before the reaction with sodium hydroxide or sodium carbonate and subsequent heating of the monosodium phosphate solution obtained to a temperature of 225-240° C. for conversion into SAPP. The dough rate of reaction of the SAPP obtained is said to be 20 to 25% after 2 min, which in the standard test for the determination of the dough rate of reaction conventionally based on a reaction time of 8 min corresponds to an SAPP having an ROR of about 28. The high content of aluminium required for reducing the ROR compared with pure SAPP is a particular disadvantage here.

For the preparation of an SAPP having a delayed dough rate of reaction, U.S. Pat. No. 2,408,258 proposes adding potash (potassium carbonate, K₂CO₃) and aluminium oxide (Al₂O₃) to a monosodium orthophosphate solution, corresponding to an amount of 0.10-0.20 wt. % of K₂O and 0.25-0.075 wt. % of Al₂O₃, based on the NaH₂PO₄, drying the solution within less than 12 sec and converting the dry monosodium orthophosphate into SAPP in a steam atmosphere at a temperature of 225-235° C. for a period of from 4 to 6 h. The dough rate of reaction of the freshly prepared SAPP is said to be about 28%, and even 30-31% after storage of the SAPP for six months. The high content of aluminium required for reducing the ROR compared with pure SAPP is also a disadvantage here.

For the preparation of an SAPP having a delayed dough rate of reaction, U.S. Pat. No. 4,804,553 proposes grinding an SAPP in the ratio of 1:10 to 1:1,000 with the oxide or hydroxide of calcium or magnesium and subsequent heat treatment at a temperature of 200-250° C. for a period of 0.25 to 2 h. A reduction in the dough rate of reaction is said to be achieved by the method. However, the description of the examples indicates that the monosodium phosphate used as a starting material for the preparation of the SAPP already comprised 0.14 wt. % of aluminium, 0.24 wt. % of calcium and 0.11 wt. % of potassium. The end product thus likewise comprises a high content of aluminium, which as is known makes a considerable contribution towards lowering the ROR compared with pure SAPP. It is to be assumed that the oxide or hydroxide of calcium or magnesium introduced by grinding is likewise present in the end product at least in a predominant proportion in the form of the oxide or hydroxide. Measurements on a correspondingly prepared SAPP with 5 wt. % of magnesium hydroxide, corresponding to a ratio of SAPP to magnesium hydroxide of 1:20, have confirmed this. Furthermore, experiments have shown that a significant reduction in the dough rate of reaction was to be achieved only by the combination of grinding the SAPP with magnesium hydroxide and subsequent heat treatment, but not by the particular individual measures by themselves.

### BRIEF SUMMARY OF THE INVENTION

The object of the present invention was to provide a modified disodium dihydrogen diphosphate (SAPP) having a delayed dough rate of reaction (ROR) with the lowest possible content of aluminium.

This object is achieved by a process for the preparation of modified disodium dihydrogen diphosphate (SAPP), wherein
a) aqueous phosphoric acid which comprises compounds of magnesium, calcium, potassium and/or aluminium dissolved in an amount which, based on the product disodium dihydrogen diphosphate, corresponds to 20 to 5,000 ppm of magnesium, 0 to 5,000 ppm of calcium, 0 to 5,000 ppm of potassium and 0 to 400 ppm of aluminium, the total amount of magnesium plus calcium plus potassium plus aluminium being at least 300 ppm, is provided,
b) an aqueous solution of sodium hydroxide or sodium carbonate is added, while stirring, and
c) the solution obtained is dewatered at a temperature in the range of from 190 to 250° C. to an orthophosphate content, measured as P₂O₅, of <5.0 wt. %.

### DETAILED DESCRIPTION OF THE INVENTION

In the context of the present invention, disodium dihydrogen diphosphate (sodium acid pyrophosphate, SAPP) having a delayed dough rate of reaction (ROR) designates a disodium dihydrogen diphosphate which has a delayed, i.e. lower dough rate of reaction (ROR) in the standard test compared with pure disodium dihydrogen diphosphate. When pure disodium dihydrogen diphosphate (SAPP) is referred to herein, this designates a product without stabilizing additives. Both in the case of pure disodium dihydrogen diphosphate and in the case of disodium dihydrogen diphosphate having a delayed dough rate of reaction (ROR) in the context of the present invention, however, small amounts of impurities due to the preparation and/or small contents of orthophosphate or higher condensation products due to the preparation cannot be ruled out and are to be included in the definition.

The modified disodium dihydrogen diphosphate according to the invention can advantageously be prepared on a large scale by spraying the prepared solution into a heated rotary tubular oven and carrying out the reaction and dewatering in the rotary tubular oven. During the dewatering, essentially only steam escapes from the rotary tubular oven. In this preparation arrangement, an essentially complete reaction of the phosphoric acid with the sodium hydroxide or sodium carbonate is to be assumed. On the basis of the composition of the prepared solution and the reaction conditions, in particular the temperature applied, it is assumed that the metal ions introduced by the prepared solution, which include in particular magnesium, calcium, aluminium and/or potassium, in addition to sodium, are present in the end product in the form of pure or mixed phosphates, this assumption not being intended to limit the scope of protection of the present invention.

The “product disodium dihydrogen diphosphate” on which the amounts of magnesium, calcium, potassium and/or aluminium are based herein, designates the modified disodium dihydrogen diphosphate obtained as the end product of the preparation process, a complete reaction of the starting substances being assumed.

Amounts stated for magnesium, calcium, potassium and aluminium in “ppm” are based on the particular elements or ions thereof and not on the starting compounds employed.

In a preferred embodiment of the process according to the invention, the amounts of the compounds of magnesium, calcium, potassium and/or aluminium dissolved in the phosphoric acid are chosen such that the modified disodium dihydrogen diphosphate (SAPP) obtained has a dough rate of reaction (ROR) in the standard test after 8 min of from 8 to 30% of CO₂. The considerably lower content of aluminium compared with an SAPP having a reduced dough rate of reaction (ROR) according to the prior art is an essential advantage of the SAPP prepared according to the invention.

In a further preferred embodiment of the process according to the invention, the amounts of the compounds of magnesium, calcium, potassium and/or aluminium dissolved in the phosphoric acid are chosen such that the modified disodium dihydrogen diphosphate (SAPP) has a dough rate of reaction (ROR) in the standard test after 8 min of from 8 to 22% of CO₂, preferably from 10 to 20% of CO₂. Such a severely delayed-action SAPP has particular advantages in particular in the production of baked goods which are to be baked only after a relatively long storage, e.g. doughs stored in the refrigerated or frozen state, which are baked only late after the dough preparation. Furthermore, the late release of carbon dioxide has an advantageous effect on the development of volume and the pore structure of the baked goods, depending on the use.

In an alternative preferred embodiment of the process according to the invention, the amounts of the compounds of magnesium, calcium, potassium and/or aluminium dissolved in the phosphoric acid are chosen such that the modified disodium dihydrogen diphosphate (SAPP) obtained has a dough rate of reaction (ROR) in the standard test after 8 min of from 22 to 30% of CO₂, preferably from 22 to 26% of CO₂. For some uses a delayed dough rate of reaction (ROR) in the abovementioned range is adequate and advantageous. Such an SAPP requires less additives which lower the dough rate of reaction (ROR), and is therefore also less expensive to prepare than a more severely delayed-action SAPP.

According to the invention, it is preferable
a) to choose the compound of magnesium dissolved in the phosphoric acid from magnesium oxide, magnesium hydroxide, magnesium carbonate, magnesium phosphates and mixtures thereof and/or
b) to choose the compound of calcium dissolved in the phosphoric acid from calcium oxide, calcium hydroxide, calcium carbonate, calcium phosphates and mixtures thereof and/or
c) to choose the compound of potassium dissolved in the phosphoric acid from potassium hydroxide, potassium carbonate, potassium phosphates and mixtures thereof and/or
d) to choose the compound of aluminium dissolved in the phosphoric acid from aluminium hydroxide, aluminium phosphates, aluminium oxide and mixtures thereof. The use of the abovementioned compounds in the preparation of the modified SAPP according to the invention has the advantage that they dissolve readily in the phosphoric acid employed as a starting substance and introduce no undesirable anions into the product.

In the process according to the invention, the phosphoric acid preferably comprises the compounds of magnesium dissolved in an amount which, based on the product disodium dihydrogen diphosphate, corresponds to 500 to 4,000 ppm, preferably 1,000 to 3,000 ppm of magnesium.

The phosphoric acid preferably comprises the compounds of calcium dissolved in an amount which, based on the product disodium dihydrogen diphosphate, corresponds to 500 to 5,000 ppm, preferably 1,000 to 4,000 ppm of calcium.

The phosphoric acid preferably comprises the compounds of potassium dissolved in an amount which, based on the product disodium dihydrogen diphosphate, corresponds to 50 to 4,000 ppm, preferably 100 to 3,000 ppm, particularly preferably 500 to 2,000 ppm of potassium. In an alternative preferred embodiment, no potassium compound is added to the phosphoric acid. However, this embodiment can also comprise potassium in small amounts as an impurity.

The phosphoric acid preferably comprises the compounds of aluminium dissolved in an amount which, based on the product disodium dihydrogen diphosphate, corresponds to 0 to 300 ppm, preferably 0 to 200 ppm, particularly preferably 0 to 100 ppm of aluminium, very particularly preferably 0 to 50 ppm of aluminium. Although aluminium can be employed in the process according to the invention in small amounts as an additive to control the dough rate of reaction (ROR), it is preferable to add no aluminium. However, if it is not added as an extra, aluminium can also be present in small amounts as an impurity.

In the process according to the invention, the total amount of magnesium plus calcium plus potassium plus aluminium contained in the aqueous phosphoric acid, based on the product disodium dihydrogen diphosphate, is at least 300 ppm. A minimum content of these modifying metal ions is necessary in order to arrive according to the invention in the range of the desired dough rate of reaction (ROR). In a preferred embodiment, the phosphoric acid comprises the compounds of magnesium, calcium, potassium and/or aluminium dissolved in an amount which, based on the product disodium dihydrogen diphosphate, corresponds to a total amount of magnesium plus calcium plus potassium plus aluminium of at least 1,000 ppm, particularly preferably at least 2,000 ppm.

In a further preferred embodiment of the process according to the invention, the aqueous solution of sodium hydroxide or sodium carbonate is added to the phosphoric acid in an amount up to a basicity, based on the molar ratio of alkali to phosphorus (Alk/P), of from 0.900 to 1.100, preferably from 0.990 to 1.040. The basicity is determined by alkalimetric back-titration of the prepared solution before the dewatering.

In a further preferred embodiment of the process according to the invention, the dewatering of the solution obtained is carried out to an orthophosphate content of <3.0 wt. %, preferably <2.0 wt. %, stated as P₂O₅.

The invention also includes a modified disodium dihydrogen diphosphate (SAPP) which
i) comprises 20 to 5,000 ppm of magnesium, 0 to 5,000 ppm of calcium, 0 to 5,000 ppm of potassium and 0 to 400 ppm of aluminium, the total amount of magnesium plus calcium plus potassium plus aluminium being at least 300 ppm,
ii) has an orthophosphate content, measured as P₂O₅, in an amount of <5.0 wt. %, preferably <3.0 wt. %, particularly preferably <2.0 wt. %, and
iii) has a dough rate of reaction (ROR) in the standard test after 8 min of from 8 to 30% of CO₂.

As stated above, the modified disodium dihydrogen diphosphate (SAPP) according to the invention has
a) a dough rate of reaction (ROR) in the standard test after 8 min of from 8 to 22% of CO₂, preferably from 10 to 20% of CO₂ or
b) a dough rate of reaction (ROR) in the standard test after 8 min of from 22 to 30% of CO₂, preferably from 22 to 26% of CO₂.

Preferably, according to the invention, the modified disodium dihydrogen diphosphate (SAPP) according to the invention comprises
i) 500 to 4,000 ppm, preferably 1,000 to 3,000 ppm of magnesium and/or
ii) 500 to 5,000 ppm, preferably 1,000 to 4,000 ppm of calcium and/or
iii) 50 to 4,000 ppm, preferably 100 to 3,000 ppm, particularly preferably 500 to 2,000 ppm of potassium and/or
iv) 0 to 300 ppm, preferably 0 to 200 ppm, particularly preferably 0 to 100 ppm of aluminium, very particularly preferably 0 to 50 ppm of aluminium.

The total amount of magnesium plus calcium plus potassium plus aluminium in a preferred embodiment is at least 1,000 ppm, particularly preferably at least 2,000 ppm.

Furthermore preferably according to the invention, the modified disodium dihydrogen diphosphate (SAPP) according to the invention has an orthophosphate content of <3.0 wt. %, preferably <2.0 wt. %, stated as P₂O₅.

The invention also includes a modified disodium dihydrogen diphosphate (SAPP) prepared or which can be prepared by the process described herein.

The invention furthermore includes the use of the modified disodium dihydrogen diphosphate (SAPP) described herein as a leavening acid for the production of baked goods.

### EXAMPLES

235.5 g of phosphoric acid (75%) are initially introduced into a 1 l three-necked flask and the amounts of calcium, magnesium, aluminium and/or potassium compounds stated in Table 1 are added. After a stirring time of approx. 30 min at 90° C. and after cooling to room temperature, 143.4 g of NaOH solution (50%) are added dropwise. The monosodium phosphate solution formed is then dried overnight in a porcelain dish in a drying cabinet at 210° C. and converted into disodium dihydrogen diphosphate. The samples are ground with a laboratory mill and sieved (75 μm). The SAPP products obtained were analysed and the dough rate of reaction (ROR) was determined in the standard test. The results are reproduced in Table 2.

TABLE 1
Amounts of calcium, magnesium, aluminium and/or potassium
compounds added to the phosphoric acid in experiments a) to i)

| Experiment | |
|---|---|
| a) | 1.00 g of Ca(OH)₂ |
| b) | 0.96 g of Mg(OH)₂ |
| c) | 1.15 g of Al(OH)₃ |
| d) | 0.96 g of Mg(OH)₂ + 1.15 g of Al(OH)₃ |
| e) | 1.00 g of Ca(OH)₂ + 0.96 g of Mg(OH)₂ |
| f) | 1.00 g of Ca(OH)₂ + 0.96 g of Mg(OH)₂ + 1.15 g of |
| | KH₂PO₄ |
| g) | 1.15 g of Ca(OH)₂ + 0.96 g of Mg(OH)₂ + 0.05 g of |
| | Al(OH)₃ |
| h) | 1.00 g of Ca(OH)₂ + 0.96 g of Mg(OH)₂ + 0.10 g of |
| | Al(OH)₃ |
| i) Comparison | — |

TABLE 2
Results of the content determinations and of the ROR determined in the
standard test for the particular SAPP product.

| | | | | | | | ROR |
|---|---|---|---|---|---|---|---|
| Experi- | P₂O₅ | Na₂O | Mg | Ca | K | Al | (% CO₂; |
| ment | (%) | (%) | (ppm) | (ppm) | (ppm) | (ppm) | 8 min) |
| a) | 65.1 | 27.6 | <50 | 3450 | <100 | <10 | 15.9 |
| b) | 63.8 | 28.0 | 2900 | <10 | <100 | <10 | 24.6 |
| c) | 64.0 | 27.0 | <50 | <10 | <100 | 2200 | 22.3 |
| d) | 64.5 | 28.0 | 2850 | <10 | <100 | 2150 | 18.6 |
| e) | 63.7 | 29.1 | 2900 | 3900 | <100 | <10 | 21.3 |
| f) | 64.4 | 28.4 | 2900 | 3500 | 1800 | <10 | 12.5 |
| g) | 64.1 | 28.7 | 2900 | 3850 | <100 | 100 | 15.1 |
| h) | 64.0 | 28.5 | 2850 | 3400 | <100 | 190 | 12.8 |
| i) | 63.4 | 27.6 | <50 | <10 | <100 | <10 | 41.8 |
| Comp. | | | | | | | |

What is claimed is:

1-17. (canceled)

18. A process for the preparation of modified disodium dihydrogen diphosphate (SAPP), comprising adding an aqueous solution comprising at least one of sodium hydroxide and sodium carbonate to an aqueous phosphoric acid solution comprising compounds selected from the group consisting of magnesium, calcium, potassium, aluminium and mixtures thereof dissolved in an amount which, based on the product disodium dihydrogen diphosphate, corresponds to 20 to 5,000 ppm of magnesium, 0 to 5,000 ppm of calcium, 0 to 5,000 ppm of potassium and 0 to 400 ppm of aluminium, the total amount of magnesium plus calcium plus potassium plus aluminium being at least 300 ppm, to obtain an aqueous solution product and dewatering the aqueous solution product at a temperature in the range of from 190 to 250° C. to obtain a modified disodium dihydrogen diphosphate product having an orthophosphate content, measured as P₂O₅, of <5.0 wt. %.

19. A process according to claim 18, wherein the amounts of the compounds of magnesium, calcium, potassium, aluminium or mixtures thereof dissolved in the phosphoric acid are chosen such that the modified disodium dihydrogen diphosphate (SAPP) has a dough rate of reaction (ROR) in the standard test after 8 min of from 8 to 30% of CO₂.

20. A process according to claim 19, wherein the amounts of the compounds of magnesium, calcium, potassium, aluminium and mixtures thereof dissolved in the phosphoric acid are chosen such that the modified disodium dihydrogen diphosphate (SAPP) has
a) a dough rate of reaction (ROR) in the standard test after 8 min of from 8 to 22% of CO₂, preferably from 10 to 20% of CO₂ or
b) a dough rate of reaction (ROR) in the standard test after 8 min of from 22 to 30% of CO₂, preferably from 22 to 26% of CO₂.

21. A process according to claim 18 wherein:
a) the compound of magnesium dissolved in the phosphoric acid is chosen from magnesium oxide, magnesium hydroxide, magnesium carbonate, magnesium phosphates and mixtures thereof and/or
b) the compound of calcium dissolved in the phosphoric acid is chosen from calcium oxide, calcium hydroxide, calcium carbonate, calcium phosphates and mixtures thereof and/or
c) the compound of potassium dissolved in the phosphoric acid is chosen from potassium hydroxide, potassium carbonate, potassium phosphates and mixtures thereof and/or
d) the compound of aluminium dissolved in the phosphoric acid is chosen from aluminium hydroxide, aluminium phosphates, aluminium oxide and mixtures thereof.

22. A process according to claim 18 wherein the phosphoric acid comprises the compounds of magnesium dissolved in an amount which, based on the product disodium dihydrogen diphosphate, comprises 500 to 4,000 ppm of magnesium.

23. A process according to claim 18 wherein the phosphoric acid comprises the compounds of magnesium dissolved in an amount which, based on the product disodium dihydrogen diphosphate, comprises 1,000 to 3,000 ppm of magnesium.

24. A process according to claim 18 wherein the phosphoric acid comprises the compounds of calcium dissolved in an amount which, based on the product disodium dihydrogen diphosphate, comprises 500 to 5,000 ppm of calcium.

25. A process according to claim 18 wherein the phosphoric acid comprises the compounds of calcium dissolved in an amount which, based on the product disodium dihydrogen diphosphate, comprises 1,000 to 4,000 ppm of calcium.

26. A process according to claim 18 wherein the phosphoric acid comprises the compounds of potassium dissolved in an amount which, based on the product disodium dihydrogen diphosphate, comprises 50 to 4,000 ppm of potassium,

27. A process according to claim 18 wherein the phosphoric acid comprises the compounds of potassium dissolved in an amount which, based on the product disodium dihydrogen diphosphate, comprises 500 to 2,000 ppm of potassium.

28. A process according to claim 18 wherein the phosphoric acid comprises the compounds of aluminium dissolved in an amount which, based on the product disodium dihydrogen diphosphate, 0 to 300 ppm, of aluminium.

29. A process according to claim 18 wherein the phosphoric acid comprises the compounds of magnesium, calcium, potassium and/or aluminium dissolved in an amount which, based on the product disodium dihydrogen diphosphate, corresponds to a total amount of magnesium plus calcium plus potassium plus aluminium of at least 1,000 ppm.

30. A process according to claim 18 wherein the aqueous solution of sodium hydroxide or sodium carbonate is added to the phosphoric acid in an amount up to a basicity, based on the molar ratio of alkali to phosphorus (Alk/P), of from 0.900 to 1.100.

31. A process according to claim 18 wherein the dewatering of the solution obtained is carried out to an orthophosphate content of <3.0 wt. % sted as P₂O₅.

32. A process according to claim 18 wherein the dewatering of the solution obtained is carried out to an orthophosphate content of <2.0 wt. %, stated as P₂O₅.

33. Modified disodium dihydrogen diphosphate (SAPP), wherein it
i) comprises 20 to 5,000 ppm of magnesium, 0 to 5,000 ppm of calcium, 0 to 5,000 ppm of potassium and 0 to 400 ppm of aluminium, the total amount of magnesium plus calcium plus potassium plus aluminium being at least 300 ppm,
ii) has an orthophosphate content, measured as P₂O₅, in an amount of <5.0 wt. %, and
iii) has a dough rate of reaction (ROR) in the standard test after 8 min of from 8 to 30% of CO₂.

34. Modified disodium dihydrogen diphosphate (SAPP) according to claim 33 wherein it has a dough rate of reaction (ROR) in the standard test after 8 min of from 10 to 20% of CO₂.

35. Modified disodium dihydrogen diphosphate (SAPP) according to claim 33 wherein the total amount of magnesium plus calcium plus potassium plus aluminium preferably being at least 1,000 ppm.

36. Modified disodium dihydrogen diphosphate (SAPP) according to claim 33 wherein it has an orthophosphate content of <3.0 wt. %, stated as P₂O₅.

37. Modified disodium dihydrogen diphosphate (SAPP) made in accordance with claim 18.

38. A method of leavening baked goods comprising incorporating a modified disodium dihydrogen diphosphate (SAPP) according to claim 18 as a leavening acid.
